(19) United States
(12) Patent Application Publication
(10) Pub. No.: US 2010/0177512 A1
(43) Pub. Date: Jul. 15, 2010

(54) LIGHTING DEVICE AND ADAPTER FOR FIXING A LAMP

(75) Inventor: Thomas Noll, Kipfenberg (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/601,843

(22) PCT Filed: May 21, 2008
(86) PCT No.: PCT/EP2008/056256

§ 371 Date: Nov. 25, 2009

(30) Foreign Application Priority Data
May 25, 2007 (DE) 10 2007 024 418.7

(51) Int. Cl. F21V 21/00; H01R 25/00

(52) U.S. Cl. 362/228; 439/121

(57) ABSTRACT

The invention relates to a lighting device having a rail device (2) that can be fixed to a surface of an object (7), said rail device having two interspaced rails (21,22) to which a lamp (3,3) can be fixed and supplied with power. At least two lamps (3,3) arranged on the rails (21,22) are provided with low voltage power via the rails (21,22) and at least two lamps (3,3) of different type can be fixed to the rails (21,22) and operated. The invention also relates to an adapter for fixing a lamp to a rail device of a lighting device.

### TECHNICAL FIELD

The invention relates to a lighting apparatus with a rail apparatus, which can be attached to a surface of an object and has two rails, which are arranged so as to be spaced apart from one another, to which a lamp can be attached and on which said lamp can be supplied with power. Furthermore, the invention relates to an adapter for attaching a lamp to a rail apparatus of a lighting apparatus.

### PRIOR ART

Such lighting apparatuses are known. Said lighting apparatuses include a plurality of halogen incandescent lamps, which are fastened on the rails and are designed for operation in the low-voltage range. Furthermore, such lighting apparatuses are also known which are designed for operation in the high-voltage range.

### DESCRIPTION OF THE INVENTION

The object of the present invention is to provide a lighting apparatus with such a rail apparatus, in which the luminous efficiency can be increased and, furthermore, the degree of flexibility of the use of components can be increased. Furthermore, the intention is to provide an adapter which can make it possible to attach a lamp in a more flexible manner.

These objects are achieved by a lighting apparatus having the features according to claim 1 and an adapter having the features according to claim 22.

A lighting apparatus according to the invention includes a rail apparatus, which can be attached to a surface of an object. For example, the rail apparatus can be attached to the ceiling of a room or to another wall of a building. The above-mentioned attachment locations should merely be understood by way of example and should in no way be understood as being exhaustive.

The rail apparatus includes two rails, which are arranged so as to be spaced apart from one another, to which at least one lamp can be attached and on which said lamp can be supplied with power. The rails are therefore designed for the transfer of power from a power supply unit, for example an AC voltage transformer or the like, up to the lamp. A power supply in the low-voltage range is provided for lamps arranged on the rails via the rails. At least two lamps can be attached to the rails and operated thereon, which lamps have a different lamp type. A lighting apparatus is thus provided which makes it possible for at least two lamps of a different lamp type to be arranged on the rails and to be capable of being operated simultaneously, these lamps being designed for operation in the low-voltage range. The low-voltage range is understood to mean voltages of less than 60 V, in particular approximately 12 V. The flexibility and compatibility of the lighting apparatus can thus be significantly increased.

The rails can be rigid components per se and be designed to be in the form of rods, for example, and to be inflexible. However, the rails can also be flexible parts, such as cables or the like.

Preferably, a first lamp type is a halogen incandescent lamp, a second lamp type is a discharge lamp, in particular a compact fluorescent lamp, and a third lamp type is a light-emitting diode. Provision can therefore be made for at least one incandescent lamp and/or at least one discharge lamp and/or at least one light-emitting diode to be arranged on the rail apparatus. In particular, the use of compact fluorescent lamps thus makes it possible to replace incandescent lamps, as a result of which a considerable energy saving is made possible by virtue of these discharge lamps, which are also referred to as energy saving lamps. Furthermore, a substantial increase in the luminous efficiency can also be ensured.

Not least the use of reflector lamps with transparent covers provides the possibility of so-called accent lighting, as a result of which quasi “ambient light” can be produced.

The invention can provide a lighting apparatus which is in the form of a hybrid system and can include lamps of different lamp types.

In the case of the replacement of an incandescent lamp by a discharge lamp, the energy saved can be used for increasing the luminous efficiency in the case of existing luminaires or for reducing the transformer power in the case of new luminaires.

Provision is preferably made for the lamps of different lamp types to be matched to one another as regards light color. In the case of discharge lamps, in particular compact fluorescent lamps, warm light colors with good color rendering are preferably provided (Ra greater than 90).

Preferably, the lamps are designed for compatible attachment to the rails, independently of the thickness (in particular the diameter in the case of round cross sections of the rails) of the rails and/or the space in between the rails. In particular, indirect attachment is provided. The rails are preferably arranged next to one another, in particular parallel to one another. The compatible attachment can make it possible in a simple and rapid manner to individually configure the lighting apparatus, since the individual components of the lighting apparatus are matched to one another in an optimum manner. The use or replacement of a wide variety of lamps can be ensured by the modular configuration of the lighting apparatus.

Preferably, the rail apparatus has two rails, which extend substantially parallel to one another and are arranged so as to be spaced apart from one another.

Preferably, a lamp is arranged on an adapter assigned to this lamp, the adapter being capable of being attached to the rails of the rail apparatus. The lamp can therefore particularly preferably be attached indirectly to the rails and arranged directly on the adapter, which is in turn arranged directly on the rails. This adapter can be used for the compatible attachment to the rails, irrespective of how thick the rails are and/or the spacing between the rails. Even in the case of a wide variety of configurations of the rail apparatus, it can thus always be possible to attach a specific lamp thereto. In order to attach the lamp to the adapter, said adapter has a suitable lampholder.

The adapter can preferably be attached releasably to the rails. In the case of two rails of the rail apparatus, the adapter is connected mechanically and electrically to both rails. Preferably, the adapter is attached to the rails in such a way that it can be released and attached in a destruction-free and reversible manner.

The adapter has at least one fastening element for fastening the adapter to the rails. In particular, provision is made for the adapter to include at least one fastening element for each rail. As a result, the adapter can be attached to the rails in a secure and reliable manner.

Preferably, at least two fastening elements are arranged on a basic body of the adapter and are capable of moving relative to one another and relative to the basic body. This configuration can make it possible for the adapter to be attached to rails of a rail apparatus with different designs in a compatible manner.

Preferably, the fastening elements are capable of moving in such a way that their spacing with respect to one another can be matched to the spacing between the rails of the rail apparatus. For this purpose, provision can in particular be made for the fastening elements to be capable of being shifted relative to one another in a guide in the basic body. As a result, an adapter can be attached to different rail apparatuses, in the case of which the rails have different spacings from one another, in a simple manner involving little complexity.

Preferably, the basic body is plate-shaped, in particular disk-shaped, and is designed to have a flat construction. This makes it possible to ensure a configuration with a minimized installation space.

A fastening element of the adapter may be a latching element or a spring element or a screw-type arrangement, which can be attached correspondingly to a rail. If necessary and in a situation-dependent manner, a respectively suitable specific configuration of a fastening element can then be formed. Depending on the accessibility, in each case optimum simple and nevertheless secure fitting can then be ensured.

Provision can be made for an adapter to be designed for attachment of only one lamp type. In this configuration, provision is then firstly made for this adapter to be capable of being attached to rail apparatuses of different designs, but secondly for only a specific lamp type to be capable of being attached to the adapter. For example, provision can be made for an adapter to be designed only for the use of an incandescent lamp, but secondly to be capable of being arranged on rail apparatuses of different designs. Furthermore, a second adapter can be provided which is designed only for attachment of a discharge lamp, but on the other hand can also be attached to a wide variety of rail apparatuses. Correspondingly, this can be provided by virtue of a third adapter, which is designed only for the attachment of a light-emitting diode.

In particular, provision is made for an adapter to be designed for attachment of a lamp type in the form of a discharge lamp, in particular in the form of a compact fluorescent lamp, and for an electronic ballast to be arranged in the adapter for the discharge lamp. The compact fluorescent lamp is particularly preferably also designed for operation on a DC voltage of 12 V and can therefore be used in solar systems. In particular, provision is made for a rectifier for rectifying the operating voltage to be arranged, in particular integrated, in this adapter for the discharge lamp.

Provision can also be made for an adapter to be designed for the compatible attachment of lamps of different lamp types. Thus, for example, provision can be made for an adapter to be designed in such a way that it is designed both for receiving or for attaching an incandescent lamp, i.e. also for attaching a discharge lamp, and for attaching a light-emitting diode. With this configuration, the compatibility can be increased further still and ultimately now only one adapter type is required, which can firstly be attached to a wide variety of rail apparatuses and can secondly be used for receiving a wide variety of lamp types.

In a further advantageous configuration, provision is made for a specifically designed rail apparatus to be assigned an adapter which is designed specifically therefor. This means that, in this embodiment, only an adapter which is designed specifically for this purpose can be attached, depending on the spacing between the rails and the thickness of the rails of a rail apparatus. Preferably, given such a configuration of the adapter, the fastening elements are attached in a positionally stable and locationally fixed manner. Nevertheless, the fastening elements can be in the form of flexible latching elements or spring elements in this case, too.

Preferably, a lamp and an adapter can be connected by means of a screw-type connection. For example, provision can be made for the lamp to have a screw-type base, which can be screwed into a lampholder of the adapter.

However, provision can also be made for a lamp and an adapter to be capable of being connected by virtue of a bayonet-type connection. A bayonet-type connection is understood to mean a connection which does also require a rotary movement of the lamp during connection or removal but, in contrast to a screw-type base, this rotary movement is less than a complete full revolution through 360°. This is not provided in the case of a screw-type base since in this case generally at least several complete revolutions are required in order to be able to position the lamp firmly in the lampholder. A bayonet-type connection can be used to produce a connection which can be released quickly and with little complexity and which ensures quick and secure insertion of the lamp.

The bayonet-type connection makes it possible for the lamp to be fastened mechanically on the adapter and furthermore also for electrical contact to be made. Preferably, the bayonet-type connection has a flat construction in comparison with a screw-type base and is therefore smaller than a screw-type base. As a result, a reduction in the installation height can be achieved, in particular in the case of discharge lamps, as a result of which the entire lighting apparatus can be designed to be smaller.

Preferably, a transparent cover, which covers a lamp on the visible side, can be attached to the adapter. Provision can also be made for a reflector to be attached to the adapter, in addition to or instead of this.

The fastening elements arranged on the adapter for fastening the adapter to the rails of the rail apparatus are in particular designed to be electrically conductive.

The lighting apparatus can have a toroidal-core transformer as the transformer and furthermore a dimmer, in particular a phase-gating dimmer. Preferably, the lamps of one lamp type in the form of discharge lamps, in particular compact fluorescent lamps, are then designed to be dimmable.

A further aspect of the invention relates to an adapter for attaching a lamp to a rail apparatus of a lighting apparatus, which adapter can be attached releasably to the rail apparatus and includes fastening elements, which can be changed reversibly for the compatible attachment to a first rail apparatus or to a second rail apparatus which is different than the first rail apparatus. As a result, the large number of component parts can be reduced and more flexible attachment can be achieved. The compatibility of the components with respect to one another can be increased.

The rail apparatus is designed for transferring power from a transformer to the lamp via the adapter.

Preferably, the fastening elements are capable of moving relative to one another. In particular, the fastening elements are arranged on a basic body of the adapter and can be shifted in a guide. This makes it possible to securely position the fastening elements and to match said fastening elements in a defined manner to the dimensions of the rail apparatus, in particular the thickness of the rails and the spacing between the rails of the rail apparatus.

The adapter preferably includes at least one lampholder, into which a lamp of a first lamp type or a lamp of a second lamp type can be introduced. As a result, in addition to the adapter being attached to different rail systems, it is also possible to ensure attachment of different lamp types, as a result of which the varied use possibilities of the adapter can be substantially increased. The adapter, as one component part, can thus be designed and used in a highly functional manner.

### BRIEF DESCRIPTION OF THE DRAWINGS

Exemplary embodiments of the invention will be explained in more detail below with reference to schematic drawings, in which:

FIG. 1 shows a perspective illustration of a first exemplary embodiment of a lighting apparatus;

FIG. 2 shows a perspective illustration of a second exemplary embodiment of a lighting apparatus;

FIG. 3 shows a perspective illustration of a third exemplary embodiment of a lighting apparatus;

FIG. 4 shows a perspective illustration of a fourth exemplary embodiment of a lighting apparatus according to the invention; and

FIG. 5 shows a side view of a further exemplary embodiment of a lighting apparatus.

### PREFERRED EMBODIMENT OF THE INVENTION

In the figures, identical or functionally identical elements have been provided with the same reference symbols.

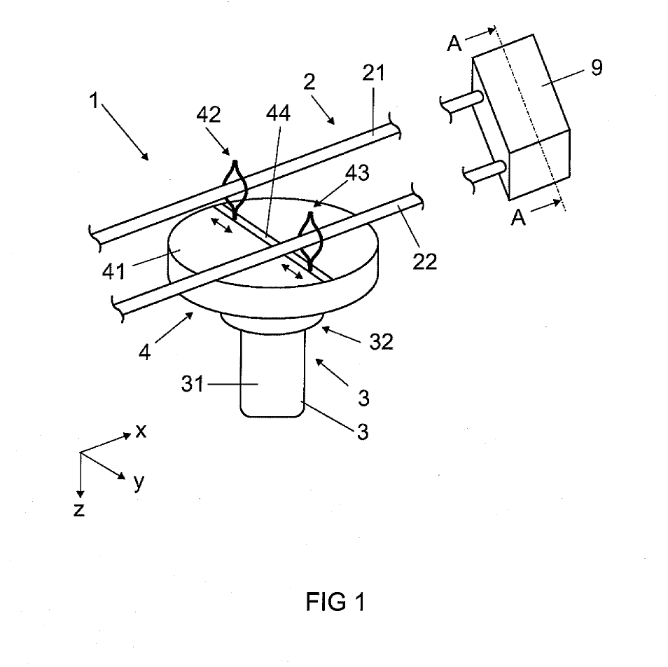

FIG. 1 shows a schematic illustration of a partial detail of a lighting apparatus 1. The lighting apparatus 1 includes a rail apparatus 2 with a first rail 21 and a second rail 22. The rail apparatus 2 can be arranged, for example, on a ceiling of a room with a suitable ceiling fastening. The two rails 21 and are formed from an electrically conductive material and extend substantially parallel to one another and spaced apart from one another.

Lamps can be attached indirectly to the rails 21 and 22.

The lighting apparatus 1 is designed in such a way that at least two lamps can be arranged on the rails 21 and 22 and can be operated simultaneously thereon, it being possible for the two lamps to be of different lamp types. This means that the lighting apparatus 1 is designed in such a way that, for example, at least one incandescent lamp, which represents a lamp of a first lamp type, and/or a compact fluorescent lamp, which represents a lamp of a second lamp type, and/or a light-emitting diode, which represents a lamp of a third lamp type, can be arranged on the rails 21 and 22 and operated simultaneously thereon.

In the embodiment shown in FIG. 1, a plurality of lamps of different lamp types are arranged on the rails 21 and 22 and can be operated thereon. In the detail illustration shown in FIG. 1, only one lamp 3 is shown, which is in the form of a compact fluorescent lamp for operation on 12 V DC voltage systems, such as solar systems, for example. The lamp 3 includes a discharge vessel 31, a region of which extends into a lower part 32 of the lamp 3. The lower part 32 is in the form of a multi-purpose lower part and includes a housing, into which the discharge vessel 31 extends at its lower end. An electronic ballast is arranged in the housing. Furthermore, the lower part 32 includes a base (not illustrated). This base can be in the form of a screw-type base or else in the form of a bayonet-type base, for example.

The lamp 3 is not fastened directly to the rails 21 and 22, but is arranged on an adapter 4. For this purpose, the adapter 4 has at least one lampholder (not illustrated). The adapter 4 includes a disk-shaped (in the exemplary embodiment) basic body 41 and fastening elements 42 and 43 arranged on the basic body 41. The lampholder is preferably arranged on the basic body 41. Provision can be made for the lampholder to be in the form of a separate component and to be fitted releasably on an upper side of the basic body 41. Likewise, however, a nonreleasable connection can also be provided. In particular, however, provision can also be made for the lampholder to be integrated in the basic body 41 and also to be formed in one piece. The lampholder can also be arranged at least partially in the basic body, as a result of which the installation height can be reduced.

These fastening elements 42 and 43 can be shifted relative to one another in a guide 44. As a result, the spacing between the fastening elements 42 and 43 can be varied in the y direction. The ability of the fastening elements 42 and 43 to move in the guide 44 is indicated symbolically by the double arrows.

The adapter 4 and the lamp 3 can be fastened on the rails 21 and 22 via the fastening elements 42 and 43 in such a way as to be capable of being released and attached again in a destruction-free manner, and therefore serves to be capable of being released in a reversible manner. The fastening elements and 43 can be spring elements, latching elements or the like. The fastening elements 42 and 43 are formed from an electrically conductive material.

A power supply to the lamp 3, which lamp is shown by way of example for all other lamps of the lighting apparatus 1, can be made possible via the rails 21 and 22, which are electrically connected to a toroidal-core transformer 9. The voltage produced by a transformer 9 is transmitted via the rails 21 and 22, the fastening elements 42 and 43 and electrical contacts arranged in the adapter 4 to the lamp 3.

The lighting apparatus 1 is in the form of a low-voltage system, as a result of which voltages of less than 60 V are provided via the rail apparatus 2 to the lamp 3. In particular, a voltage of approximately 12 V is provided for a lamp 3.

Preferably, in the case of such a configuration with a lamp 3 in the form of a discharge lamp, a rectifier is provided in the adapter 4. This rectifier can be arranged so as to be integrated in the basic body 41.

The adapter 4 shown in FIG. 1 makes it possible for the lamp 3 to be attached to different rail apparatuses 2. It is thus possible for the adapter 4 to be attached independently of the thickness of the rails 21 and 22 and of the spacing between them (spacing in the y direction). This is made possible by virtue of the fact that the fastening elements 42 and 43 can be shifted in a situation-dependent manner and the elastic and flexible configuration of these fastening elements 42 and 43 also makes it possible for the adapter to be snapped or latched onto the rails 21 and 22 or attached in a similar manner.

Provision can be made for the adapter 4 to be designed merely for attaching or for inserting a lamp 3 of a specific lamp type. This means that only one lamp 3 in the form of a discharge lamp can be attached to the specific adapter 4. An incandescent lamp or a light-emitting diode can in this case not be attached to this adapter 4. In the case of such an embodiment, a specific adapter 4 is provided for each lamp type, and this adapter is provided merely for attaching a specific lamp type, but can nevertheless be attached to a wide variety of rail apparatuses 2.

Likewise, however, provision can also be made for it to be possible for an incandescent lamp or a light-emitting diode to also be attached to the adapter 4 shown in FIG. 1 instead of the lamp 3 illustrated as a discharge lamp. The adapter 4 in such an embodiment is then also designed in a compatible manner as regards the attachment of lamps of different lamp types.

Preferably, the lighting apparatus 1 also has a phase-gating dimmer (not illustrated), which makes it possible to dim the lamps associated with the lighting apparatus 1.

The lamp 3 in the form of a discharge lamp can be formed with an electronic ballast integrated in the housing of the lower part 32. Likewise, however, provision can also be made for such an electronic ballast to be arranged externally with respect to the housing and also with respect to the lower part 32 of the lamp 3.

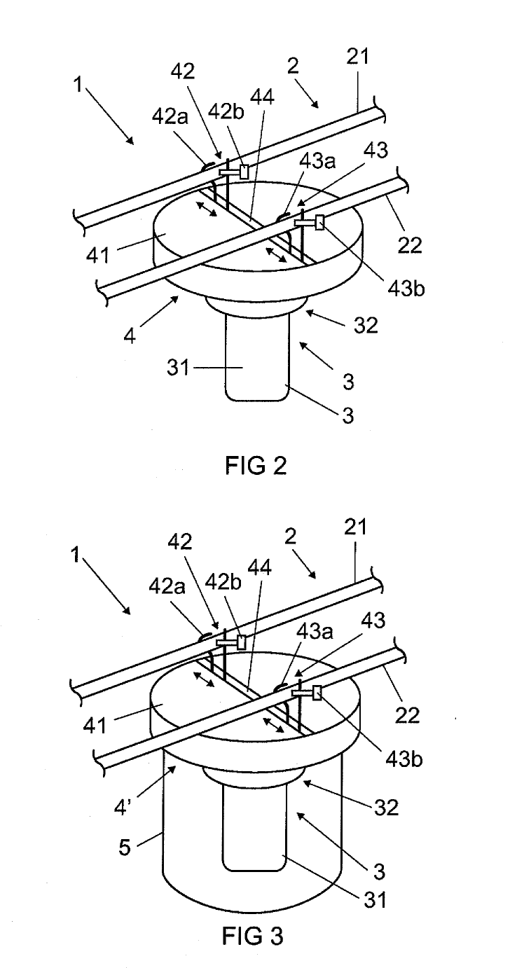

FIG. 2 shows a schematic illustration of a further exemplary embodiment. In contrast to the illustration shown in FIG. 1, provision is made here for the fastening elements 42 and 43 to not be spring elements or latching elements as such, but for a screw-type connection to be provided, with which the adapter 4 can be fastened onto the rails 21 and 22. For this purpose, fastening clips 42a and 43a are provided, which can be fastened with screws 42b and 43b, respectively, to the rails 21 and 22.

Moreover, the adapter 4 can be designed in accordance with the configuration in FIG. 1 or an alternative specified therein. Preferably, the adapter 4, in particular the basic body 41, can also surround regions of the rails 21 and 22.

FIG. 3 shows a further embodiment of a lighting apparatus 1 in a perspective illustration in a partial detail. In contrast to the configuration shown in FIG. 1 and FIG. 2, provision is made here for an adapter 4′ to be designed specifically for a rail apparatus 2 and to be assigned to this rail apparatus. In this case, too, the spacing between the fastening elements 42 and 43 is permanently predetermined depending on the spacing (in the y direction) between the rails 21 and 22. This means that the fastening elements 42 and 43 are arranged such that they are not capable of moving relative to one another in the y direction. As regards the configuration of the fastening elements 42 and 43, reference is made to the embodiment in FIG. 2.

The adapter 4′ in the illustration shown in FIG. 3 can therefore only be attached to this specific system or this specific rail apparatus 2.

Provision is thus made for a first rail apparatus to be assigned a specific first adapter provided for this purpose and for a second rail apparatus, for example, which has a different spacing between the rails 21 and 22 in comparison with the first rail apparatus, to be assigned a second adapter. Each rail apparatus 2, which has been individualized in respect of the spacing provided between the rails 21 and 22, is therefore assigned an adapter 4′ matched thereto, in which adapter the fastening elements 42 and 43 then also have a corresponding spacing with respect to one another.

Provision can then also be made here for only lamps of a specific lamp type to be capable of being attached to a specific adapter 4′. Likewise, however, provision can also be made for lamps of different lamp types to also be capable of being attached in a compatible manner in the case of such a specific adapter 4′ for a specific rail apparatus 2.

Furthermore, the lighting apparatus 1 shown in the illustration in FIG. 3 has a cover 5. The cover 5 is a transparent cover 5, which covers the lamp 3 on the visible side and can be attached releasably to the adapter 4′, in particular to the basic body 41. The cover 5 in FIG. 3 is in the form of a cylindrical pot, by way of example. Likewise, however, a funnel-shaped configuration or else a different shape can also be provided.

Provision can also be made for the lighting apparatus 1 to have a reflector (not illustrated), which can be attached releasably to the adapter 4′ or the basic body 41.

A cover 5 and/or a reflector can also be provided in the embodiments shown in FIG. 1 and FIG. 2.

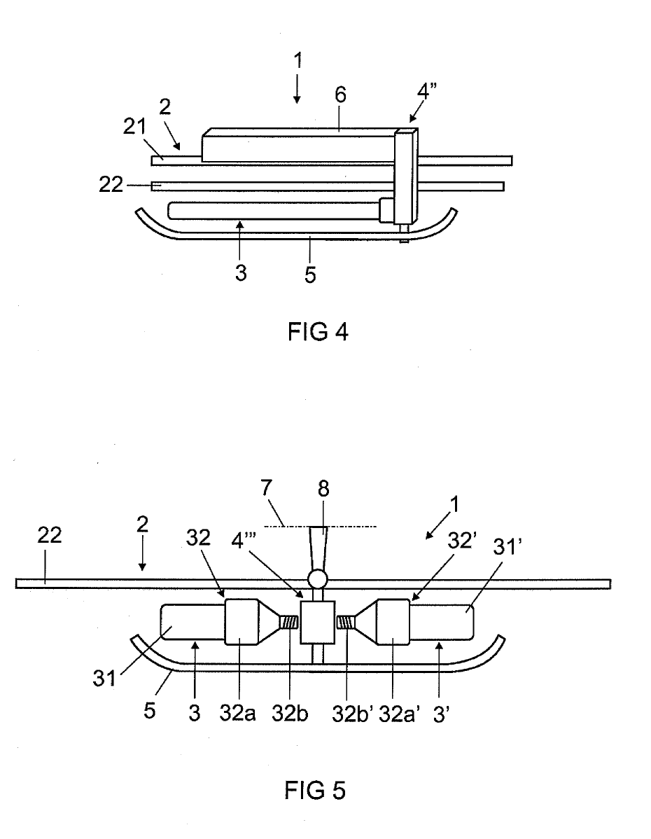

FIG. 4 shows a perspective, schematic illustration of a further exemplary embodiment of a lighting apparatus 1. In this embodiment, a lamp 3 is provided, which is shown as a discharge lamp and which is arranged on the adapter 4″. The lamp 3 has an external operating device or an external electronic ballast 6, which is likewise connected to the adapter 4″. The adapter 4″ is arranged with webs or fastening elements (not illustrated) on the rails 21 and 22. The lamp 3 is in turn covered on the visible side with a transparent cover 5. Electrical and mechanical contact is made with the components of rails 21 and 22, the lamp 3 and the electronic ballast 6 via the adapter 4″.

In the embodiment shown in FIG. 4, the adapter 4″ can be arranged to the side of the rails 21 and 22. Particularly advantageous, however, is an arrangement of the adapter 4″ between the rails 21 and 22. This is shown in the illustration in FIG. 4.

Provision can also be made for a lampholder, into which the lamp 3 can be attached, to be formed on the electronic ballast G.

FIG. 5 shows a schematic side view of a further embodiment of a lighting apparatus 1. In this embodiment, more than one lamp, in the exemplary embodiment two lamps 3 and 3′, can be attached to an adapter 4′″. In the exemplary embodiment, both lamps 3 and 3′ are in the form of compact fluorescent lamps. In the schematic illustration in FIG. 5, the lamps 3 and 3′ are illustrated as having been rotated out of the adapter 4′″ in order to be able to illustrate the bases in the form of a screw-type base 32b and 32b′. The lower parts 32 and 32′ of the lamps 3 and 3′, respectively, comprise housings 32a and 32a′, to which the bases 32b and 32b′ are fastened. Electronic ballasts are arranged in the housings 32a and 32a′ and are designed for operation on a DC voltage of 12 V.

A rectifier is arranged in the adapter 4′″. The system shown in FIG. 5 is fastened on a ceiling 7 of a room via at least one ceiling fastening 8. The discharge vessels 31 and 31′ of the lamps 3 and 3′, respectively, are fastened on the lower parts 32 and 32′, respectively.

The transformers used in such lighting apparatuses 1 for the low-voltage range are generally toroidal-core transformers, which produce AC voltages of between 10.5 V and 12 V as output voltages. However, a DC voltage of approximately 12 V is required for operation of conventional compact fluorescent lamps with integrated electronic ballasts which are designed for operation in solar systems. The additional electronics arranged in the adapter 4′″ are therefore required for the rectification and smoothing of the AC voltage of the transformer.

The lighting apparatuses 1 can be designed for dimmable operation of the lamps 3 and 3′. Likewise, however, a non-dimmable embodiment can also be provided.

In addition to the mentioned screw-type bases or bayonet-type connections between an adapter and a lamp 3 and 3′, a pin-type base or else different types of bases can also be provided, for example.

1. A lighting apparatus with a rail apparatus, which is configured to be attached to a surface of an object and has two rails, which are arranged so as to be spaced apart from one another, to which a lamp can be attached and on which said lamp can be supplied with power,
wherein the lighting apparatus is configured such that a power supply in the low-voltage range for lamps arranged on the rails takes place via the rails, and at least two lamps of a different lamp type can be attached to the rails and operated thereon.

2. The lighting apparatus as claimed in claim 1,
wherein the at least two lamps of different lamp types are arranged simultaneously on the rails and can be operated simultaneously.

3. The lighting apparatus as claimed in claim 1,
wherein the lamps are designed for compatible attachment to the rails, independently of at least one of the thickness of the rails and the spacing between the rails.

4. The lighting apparatus as claimed in claim 1,
wherein a first lamp type is an incandescent lamp, a second lamp type is a discharge lamp, and a third lamp type is a light-emitting diode.

5. The lighting apparatus as claimed in claim 1,
wherein the rail apparatus has two rails, which extend substantially parallel to one another and are arranged so as to be spaced apart from one another.

6. The lighting apparatus as claimed in claim 1, further comprising:
an adapter, which is configured such it can be attached to the rails;
wherein a lamp is arranged on the an adapter.

7. The lighting apparatus as claimed in claim 6,
wherein the adapter is configured such that it can be attached releasably to the rails.

8. The lighting apparatus as claimed in claim 6,
wherein the adapter comprises at least one fastening element configured to fasten the adapter on the rails.

9. The lighting apparatus as claimed in claim 8,
wherein at least two fastening elements are arranged on a basic body of the adapter and are configured such that they are capable of moving relative to one another and relative to the basic body.

10. The lighting apparatus as claimed in claim 9,
wherein the fastening elements are configured such that they are capable of being moved in such a way that their spacing with respect to one another can be matched to the spacing between the rails of the rail apparatus.

11. The lighting apparatus as claimed in claim 9,
wherein the fastening elements are configured such that they can be shifted relative to one another in a guide in the basic body.

12. The lighting apparatus as claimed in claim 9,
wherein the basic body is plate-shaped and is designed to have a flat construction.

13. The lighting apparatus as claimed in claim 8,
wherein a fastening element is a latching element or a spring element or a screw-type arrangement, which can be attached correspondingly to a rail.

14. The lighting apparatus as claimed in claim 6
wherein the adapter is designed for the attachment of only one lamp type.

15. The lighting apparatus as claimed in claim 14,
wherein a first adapter is designed for attaching a lamp type in the form of a discharge lamp, in particular a compact fluorescent lamp, and a voltage rectifier for the discharge lamp is arranged in the adapter.

16. The lighting apparatus as claimed in claim 6,
wherein the adapter is designed for attachment of different lamp types.

17. The lighting apparatus as claimed in claim 6,
wherein a specifically designed rail apparatus is assigned the adapter which is specifically designed therefor.

18. The lighting apparatus as claimed in claim 6,
wherein a lamp and the adapter are configured such that they can be connected by means of a screw-type connection.

19. The lighting apparatus as claimed in claim 6,
wherein a lamp and the adapter are configured such that they can be connected by a bayonet-type connection.

20. The lighting apparatus as claimed in claim 6, further comprising:
a transparent cover, which covers a lamp on the visible side, wherein the transparent cover is configured such that it can be attached to the adapter.

21. The lighting apparatus as claimed in claim 6, further comprising:
a reflector being configured such that it can be attached to the adapter.

22. An adapter for attaching a lamp to a rail apparatus of a lighting apparatus, which adapter is configured such that it can be attached releasably to the rail apparatus and comprises fastening elements, which are configured such that they can be changed reversibly for the compatible attachment to a first rail apparatus or to a second rail apparatus which is different than the first rail apparatus.

23. The adapter as claimed in claim 22,
wherein the fastening elements are configured such that they are capable of being moved relative to one another.

24. The adapter as claimed in claim 23,
wherein the fastening elements are arranged on a basic body of the adapter and are configured such that they can be shifted in a guide.

25. The adapter as claimed in claim 22,
wherein the adapter comprises a lampholder, in which a lamp of a first lamp type or a lamp of a second lamp type can be introduced.
